(19) United States
(12) Patent Application Publication
(10) Pub. No.: US 2014/0204306 A1
(43) Pub. Date: Jul. 24, 2014

(54) LCD MODULE AND LCD DEVICE

(71) Applicant: SHENZHEN CHINA STAR OPTOELECTRONICS TECHNOLOGY CO., LTD., Shenzhen (CN)

(72) Inventor: Dehua Li, Shenzhen (CN)

(73) Assignee: SHENZHEN CHINA STAR OPTOELECTRONICS TECHNOLOGY CO., LTD., Shenzhen (CN)

(21) Appl. No.: 13/806,838

(22) PCT Filed: Nov. 27, 2012
(86) PCT No.: PCT/CN2012/085315

§ 371 Date: Dec. 24, 2012

(30) Foreign Application Priority Data
Nov. 23, 2012 (CN) 201210480729.4

(51) Int. Cl. G02F 1/1333

(52) U.S. Cl. CPC G02F 1/133308
USPC 349/58

(57) ABSTRACT

A liquid crystal display (LCD) module and an LCD device. The LCD module includes a front frame and a backplane. A side wail of the front frame is turned inwards to form a connecting structure. The connecting structure comprises a bottom all and a side wall. The side wall of the connecting structure and a side wall of the backplane are mutually parallel and are fixed by a fastening structure. Outer surface of the front frame is smooth and the front frame may be arranged as an outermost layer of the LCD device.

### TECHNICAL FIELD

The present disclosure belongs to the field of liquid crystal displays (LCDs), and more particularly to an LCD module and an LCD device.

### BACKGROUND

A typical liquid crystal display (LCD) device generally includes an LCD module, a circuit board, a front cover, and a back cover. The LCD module includes an LCD panel, a backlight module, a front frame, and a backplane. As shown in FIG. 1, because the front frame 1 is used to fix the LCD panel and the backlight module, the front frame 1 is configured with a fixing structure 7 of a hole or a protrusion structure. As a result, the front frame 1 may not look so pleasing and may not be directly arranged as an outermost layer of the LCD device. Thus, the LCD device is configured with the front cover to cover the front frame, beautifying the LCD device. If an outer surface of the front frame is smooth and has no the fixing structure, the LCD device may be only configured with the front frame without use of the front cover.

### SUMMARY

In view of the above-described problems, the aim of the present disclosure is to provide a liquid crystal display (LCD) module and an LCD device. A front frame of the LCD module does not need to install a fixing structure of a hole or a protrusion structure, and the front frame may be arranged as an outermost layer of the LCD device.

A first technical scheme of the present disclosure is that: An LCD module comprises a front frame and a backplane. A side wall of the front frame is turned inwards to form a connecting structure. The connecting structure comprises a bottom wall and a side wall. The side wall of the connecting structure and a side wall of the backplane are mutually parallel and are fixed by a fastening structure. The side wall of the connecting structure is configured with a through hole. The side wall of the backplane is correspondingly configured with a clamping structure. The clamping structure is fixed to the through hole. A same side wall of the front frame is configured with a plurality of connecting structures. The connecting structures are arranged at intervals along the side wall of the front frame. Four side walls of the front frame are all configured with the connecting structure.

A second technical scheme of the present disclosure is that: An LCD module comprises a front frame and a backplane. A side wall of the front frame is turned inwards to form a connecting structure. The connecting structure comprises a bottom wall and a side wall. The side wall of the connecting structure and a side wall of the backplane are mutually parallel and are fixed by a fastening structure.

In one example, the side wall of the connecting structure is configured with a clamping structure. The side wall of the backplane is correspondingly configured with a through hole. The clamping structure is fixed to the through hole.

In one example, the side wall of the connecting structure is configured with a through hole. The side wall of the backplane is correspondingly configured with a clamping structure. The clamping structure is fixed to the through hole.

In one example, a same side wall of the front frame is configured with a plurality of connecting structures. The connecting structures are arranged at intervals along the side wall of the front frame. Thus, weight of the front frame is increased slightly so as to conform to a development trend of thinning of the LCD device.

In one example, a same side wall of the front frame is only configured with one connecting structure. The connecting structure is configured with a plurality of groups of fastening structures. The side wall of the connecting structure has a greater strength, and the fastening structure is stronger to fix.

In one example, four side walls of the front frame are all configured with the connecting structure.

In one example, only two opposite side walls of the front frame are configured with the connecting structure.

A third technical scheme of the present disclosure is that: An LCD device comprises the LCD module mentioned above.

In one example, the front frame acts as a front cover of the LCD device. The LCD device further comprises a back cover. The bottom wall of the connecting structure is also configured with a screw hole. The back cover is configured with a through hole. The back cover is locked to the front frame by a fastener.

In one example, an inner hole flanging, increasing a fit length of the screw hole, is also arranged at the screw hole on the bottom wall of the connecting structure, thus increasing locking, strength of the fastener.

The present disclosure has the advantages that the LCD module of the present disclosure comprises the front frame and the backplane. The side wall of the front frame is turned inwards to form the connecting structure. The connecting structure comprises the bottom wall and the side wall. The side wall of the connecting structure and the side wall of the backplane are mutually parallel and are fixed by fastening structures so that the LCD panel and the backlight module are fixed between the front frame and the backplane. Thus, outer surface of the front frame does not need be configured with the fixing structure of the hole or the protrusion structure. The outer surface of the front frame is smooth and the front frame may be arranged as the outermost layer of the LCD device.

### BRIEF DESCRIPTION OF FIGURES

FIG. 1 is a structural diagram of a front frame of a typical liquid crystal display (LCD) module;

FIG. 2 is a structural diagram of disassembly of an example of a liquid crystal display (LCD) device of the present disclosure;

FIG. 3 is a structural diagram of a section of an example of a liquid crystal display (LCD) device of the present disclosure;

FIG. 4 is a structural diagram of a section of a front frame in an example of a liquid crystal display (LCD) device of the present disclosure;

FIG. 5 is a sectional diagram of a front frame in an example of a liquid crystal display (LCD) device of the present disclosure; and

FIG. 6 is a structural diagram of a section of another example of a front frame in a liquid crystal display (LCD) device of the present disclosure.

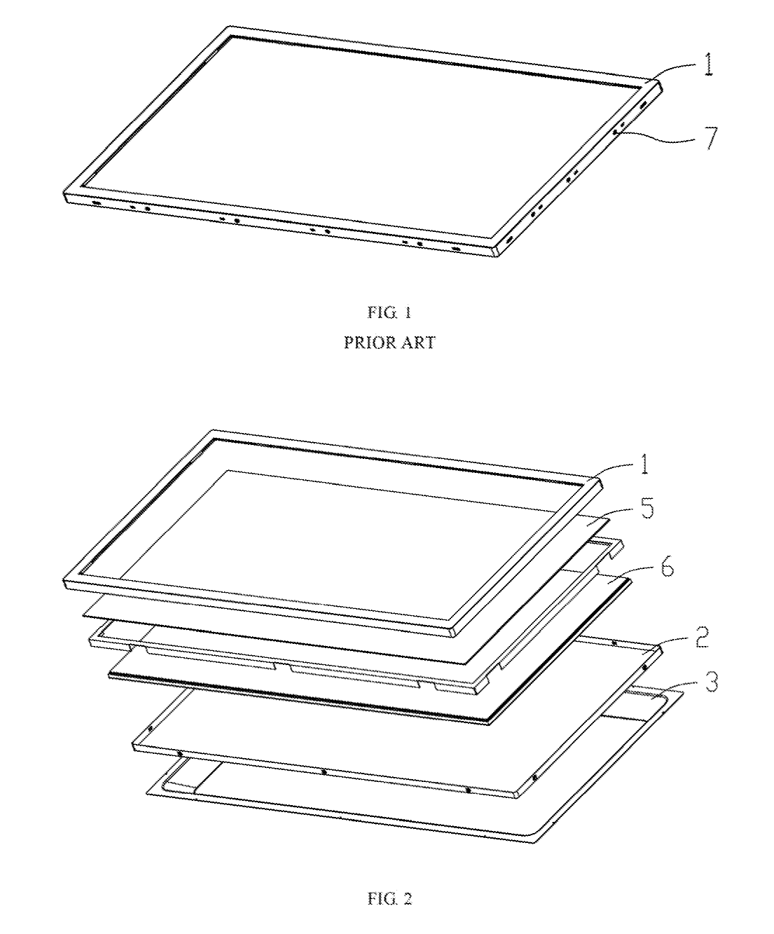

### DETAILED DESCRIPTION

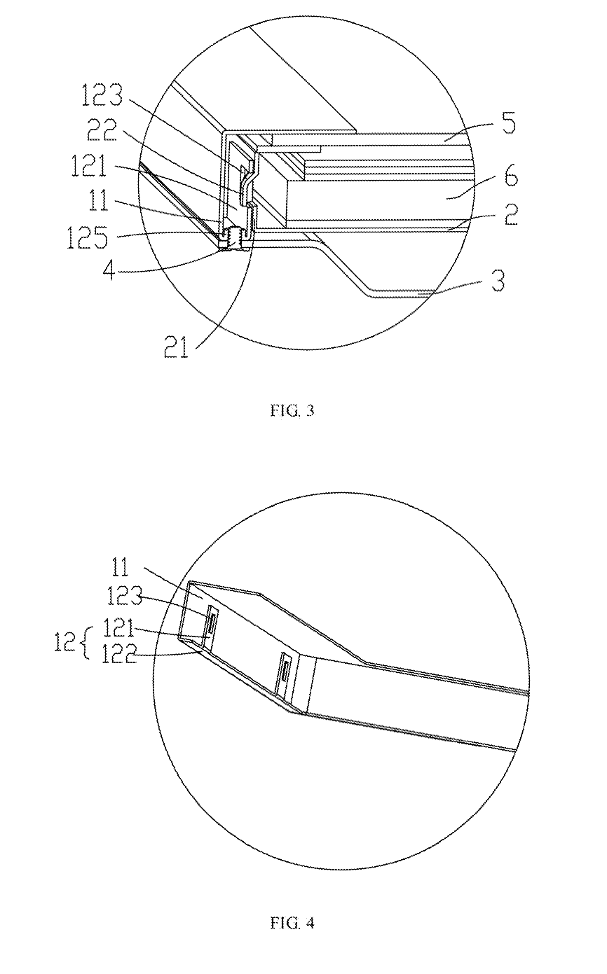

The present disclosure discloses a liquid crystal display (LCD) device. As shown in FIG. 2-FIG. 5, a first example of the LCD device of the present disclosure comprises an LCD module. The LCD module comprises an LCD panel 5, a backlight module 6, a front frame 1, and a backplane 2. A side wall 11 of the front frame is turned inwards to form a connecting structure 12. The connecting structure 12 comprises a bottom wall 122 of the connecting structure and a side wall 121 of the connecting structure. The side wall 121 of the connecting structure and a side wall 21 of the backplane are mutually parallel and are fixed by a fastening structure. The LCD panel 5 and the backlight module 6 are fixed between the front frame 1 and the backplane 2.

The side wall 11 of the front frame of the LCD module of the present disclosure is turned inwards to form the connecting structure 12. The connecting structure comprises the bottom wall and the side wall. The side wall 121 of the connecting structure and the side wall 21 of the backplane are mutually parallel and are fixed by the fastening structure, so that the LCD panel 5 and the backlight module 6 are fixed between the front frame 1 and the backplane 2. Thus, outer surface of the front frame 1 does not need to be configured with a fixing structure of a hole or a protrusion structure, The outer surface of the front frame 1 is smooth and the front frame 1 may be arranged as an outermost layer of the LCD device.

In the example, specific structure of the fastening structure is that: The side wall 121 of the connecting structure is configured with a through hole 123. The side wall 21 of the backplane is correspondingly configured with a clamping structure 22. The clamping structure 22 is fixed to the through hole 123. In an assembly process of the front frame 1 and the backplane 2, the clamping structure 22 is extruded by the side wall 11 of the front frame and bents inwards to generate elastic deformation. After the clamping structure 22 enters the through hole 123, the clamping structure 22 returns to an original position through elastic deformation, and is damped to the through hole 123.

It should be understood that the side wall of the connecting structure is configured with the clamping structure 22. The side wall of the backplane is correspondingly configured with the through hole 123. The clamping structure 22 is fixed to the through hole 123. An aim of the present disclosure can also be achieved by only exchanging positions of the clamping structure and the through hole 123, obtaining a same advantage.

In the example, the outer surface of the front frame 1 is not configured with the fixing structure of the hole or the protrusion structure, and the outer surface of the front frame 1 is smooth and the front frame 1 may be arranged as the outermost layer of the LCD device. Thus, in the example, the front frame 1 acts as a front cover of the LCD device, decreasing number of components and reducing costs. in addition, the LCD device further comprises a back cover 3. The bottom wall 122 of the connecting structure is also configured with a screw hole 124. The back cover 3 is configured with a through hole. The back cover 3 is locked to the front frame 1 by a fastener 4. Thus, the LCD panel 5, the backlight module 6, and the backplane 2 are all fixed between the front frame 1 and the back cover 3.

In order to increase locking strength of the fastener 4, an inner hole flanging 125, increasing a fit length of the screw hole, is also arranged at the screw hole 124 on the bottom wall 122 of the connecting structure.

In the example, a same side wall of the front frame 1 is configured with a plurality of connecting structures 12. The connecting structures 12 are arranged at intervals along the side wall 11 of the front frame. The connecting structure 12 is short. On the premise of ensuring strength of the connecting structure, only the fastening structure, the screw hole, and the inner hole flanging are may be arranged. Thus, weight of the front frame 1 is increased slightly so as to conform to a development trend of thinning of the LCD device.

In the example, four side walls of the front frame 1 are all configured with the connecting structure 12. Thus, the front frame 1 and the backplane 2 are fixed in four directions, with a greater strength. Certainly, only two opposite side walls of the front frame may be configured with the connecting structure. The fastening structure only performs a pre-positioning function. Finally, ultimate locking fixation is completed by the fastener between the from frame and the back cover.

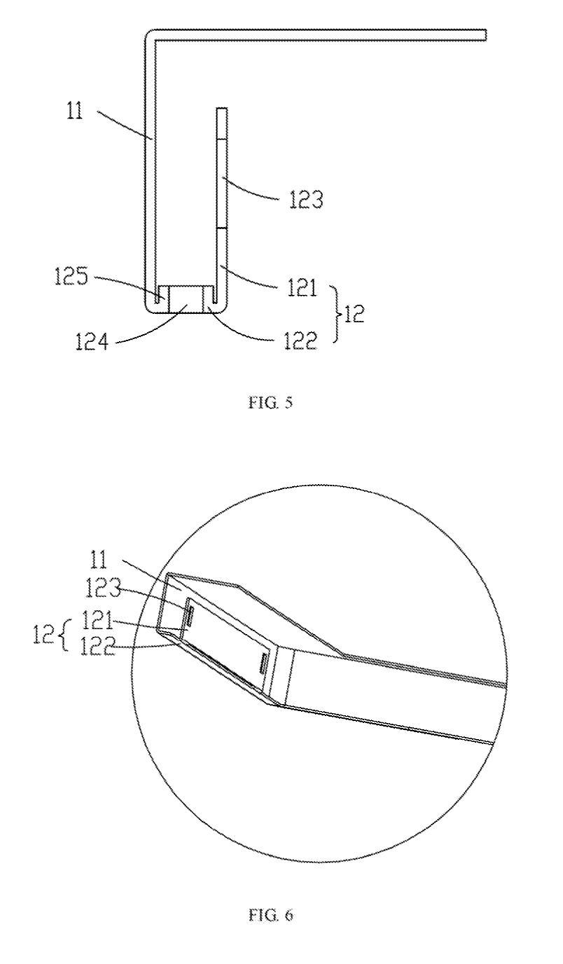

FIG. 6 shows a second example of the from frame of the LCD module of the present disclosure, a difference between the second example and the first example is that the same side wall of the front frame is configured with only one connecting structure 12 in the second example. However, the connecting structure 12 is configured with a plurality of groups of clamping structures, and the clamping structure of the connecting structure is the through hole 123. The side wall 121 of the connecting structure has a greater strength, and the fastening structure is stronger to fix, obtaining the same advantage.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A liquid crystal display (LCD) module, comprising:
a front frame; and
a backplane;
wherein a side wall of the front frame is turned, inwards to form a connecting structure, the connecting structure comprises as bottom wall and a side wall, the side wall of the connecting structure and a side wall of the backplane are mutually parallel and are fixed by a fastening structure; wherein the side wall of the connecting structure is configured with a through hole, the side wall of the backplane is correspondingly configured with a clamping structure, the clamping structure is fixed to the through hole, wherein a same side wall of the front frame is configured with a plurality of connecting structures, the connecting structures are arranged at intervals along the side wall of the front frame, and four side walls of the front frame are all configured with the connecting structure.

2. A liquid crystal display (LCD) module, comprising:
a front frame; and
a backplane;
wherein a side wall of the front frame is turned inwards to form a connecting structure, the connecting structure comprises a bottom wall and a side wall, the side wall of the connecting structure and a side wall of the backplane are mutually parallel and are fixed by a fastening structure.

3. The liquid crystal display (LCD) module of claim 2, wherein the side wall of the connecting structure is configured with a clamping structure, and the side wall of the backplane is correspondingly configured with a through hole, and the clamping structure is fixed to the through hole.

4. The liquid crystal display (LCD) module of claim 2, wherein the side wall of the connecting structure is configured with a through hole, and the side wall of the backplane is correspondingly configured with a clamping structure, and the clamping structure is fixed to the through hole.

5. The liquid crystal display (LCD) module of claim 2, wherein a same side wall of the front frame is configured with a plurality of connecting structures, and the connecting structures are of arranged at intervals along the side wall of the front frame.

6. The liquid crystal display (LCD) module of claim 2, wherein a same side wall of the front frame is only configured with one connecting structure, and the connecting structure is configured with a plurality of groups of fastening structures.

7. The liquid crystal display (LCD) module of claim 2, wherein four side walls of the front frame are all configured with the connecting structure.

8. The liquid crystal display (LCD) module of claim 2, wherein only two opposite side walls of the front frame are configured with the connecting structure.

9. A liquid crystal display (LCD) device, comprising:
an LCD module, wherein the LCD module comprises a front frame and a backplane, a side wall of the front frame is turned inwards to form a connecting structure; wherein the connecting structure comprises a bottom wall and a side wall, and the side wall of the connecting structure and a side wall of the backplane are mutually parallel and are fixed by a fastening structure.

10. The liquid crystal display (LCD) device of claim 9, wherein the side wall of the connecting structure is configured with a clamping structure, the side will of the backplane is correspondingly configured with a through hole, and the clamping structure is fixed to the through hole.

11. The liquid crystal display (LCD) device of claim 9, wherein the side wall of the connecting structure is configured with a through hole, the side wall of the backplane is correspondingly configured with a clamping structure, and the clamping structure is fixed to the through hole.

12. The liquid crystal display (LCD) device of Claim wherein a same side wall of the front frame is configured with a plurality of connecting structures, and the connecting structures are arranged at intervals along the side wall of the front frame.

13. The liquid crystal display (LCD) device of claim 9, wherein a same side wall of the front frame is only configured with one connecting structure, and the connecting structure is configured with a plurality of groups of fastening structures.

14. The liquid crystal display (LCD) device of claim 9, wherein four side walls of the front frame are all configured with the connecting structure.

15. The liquid crystal display (LCD) device of claim 9, wherein only two opposite side walls of the from frame are configured with the connecting structure.

16. The liquid crystal display (LCD) device of claim 9, wherein the front frame acts as a front cover of the LCD device, the LCD device further comprises a back cover, the bottom wall of the connecting structure is also configured with a screw hole, the back cover is configured with a through hole, the back cover is locked to the front frame by a fastener.

17. The liquid crystal display (LCD) device of claim 16, wherein an inner hole flanging, increasing a fit length of the screw hole, is also arranged at the screw hole on the bottom wall of the connecting structure.
